(19) United States
(12) Patent Application Publication
(10) Pub. No.: US 2022/0129690 A1
(43) Pub. Date: Apr. 28, 2022

(54) IDENTIFICATION METHOD, IDENTIFICATION SYSTEM, AND NON-TRANSITORY COMPUTER-READABLE STORAGE MEDIUM STORING A PROGRAM

(71) Applicant: SEIKO EPSON CORPORATION, Tokyo (JP)

(72) Inventors: Akira IKEDA, Chino-shi (JP); Takumi OIKE, Matsumoto-shi (JP)

(73) Assignee: SEIKO EPSON CORPORATION, Tokyo (JP)

(21) Appl. No.: 17/510,734

(22) Filed: Oct. 26, 2021

(30) Foreign Application Priority Data
Oct. 27, 2020 (JP) 2020-179520

(51) Int. Cl. G06K 9/32; G06K 9/00; G06K 9/46

(52) U.S. Cl. CPC G06K 9/3233; G06K 2209/21; G06K 9/4661; G06K 9/00979

(57) ABSTRACT

There is provided an identification method including acquiring a first image, a pixel value of each of pixels of which represents a distance from a first position to a first imaging target object including a background object and an identification target object, acquiring a second image captured from the first position or a second position different the first position, a pixel value of each of pixels of the second image representing at least luminance of reflected light from the first imaging target object, specifying, based on the first image, a first region occupied by the identification target object in the first image, and identifying a type of the identification target object based on an image of a second region corresponding to the first region in the second image.

The present application is based on, and claims priority from JP Application Serial Number 2020-179520, filed Oct. 27, 2020, the disclosure of which is hereby incorporated by reference herein in its entirety.

### BACKGROUND

### 1. Technical Field

The present disclosure relates to an identification method, an image display method, an identification system, an image display system, and a program.

### 2. Related Art

Examples of an identification technique for identifying a type of an object imaged in a captured image captured by a camera include a technique disclosed in JP-A-2010-191745 (Patent Literature 1). The technique disclosed in Patent Literature 1, the type of the object imaged in the captured image is identified by template matching of the object imaged in the captured image and a template image of the object saved in a database. In the technique disclosed in Patent Literature 1, an image corresponding to the identified type is projected onto the object.

In the technique disclosed in Patent Literature 1, when a color of an identification target object and a color of a background are similar tints, a type of the object cannot be accurately identified.

### SUMMARY

An identification method according to an aspect of the present disclosure includes: acquiring a first image, a pixel value of each of pixels of which represents a distance of a first imaging target object including a background object and an identification target object from a first position; acquiring a second image captured from the first position or a second position different the first position, a pixel value of each of pixels of the second image representing at least luminance of reflected light from the first imaging target object; specifying, based on the first image, a first region occupied by the identification target object in the first image; and identifying a type of the identification target object based on an image of a second region corresponding to the first region in the second image.

An image display method according to an aspect of the present disclosure includes: acquiring a first image, a pixel value of each of pixels of which represents a distance of a first imaging target object including a background object and an identification target object from a first position; acquiring a second image captured from the first position or a second position different the first position, a pixel value of each of pixels of the second image representing at least luminance of reflected light from the first imaging target object; specifying, based on the first image, a first region occupied by the identification target object in the first image; identifying a type of the identification target object based on an image of a second region corresponding to the first region in the second image; and displaying, over the identification target object, a fourth image corresponding to the type of the identification target object, the fourth image being an image for decorating the identification target object.

An identification system according to an aspect of the present disclosure includes: a first imaging device set in a first position and configured to capture a first image, a pixel value of each of pixels of which represents a distance of a first imaging target object including a background object and an identification target object from the first position; a second imaging device set in the first position or a second position different from the first position and configured to capture a second image, a pixel value of each of pixels of which represents at least luminance of reflected light from the first imaging target object; and a processing device. The processing device executes: acquiring the first image from the first imaging device; acquiring the second image from the second imaging device; specifying, based on the first image, a first region occupied by the identification target object in the first image; and identifying a type of the identification target object based on an image of a second region corresponding to the first region in the second image.

An image display system according to an aspect of the present disclosure includes: a first imaging device set in a first position and configured to capture a first image, a pixel value of each of pixels of which represents a distance of a first imaging target object including a background object and an identification target object from the first position; a second imaging device set in the first position or a second position different from the first position and configured to capture a second image, a pixel value of each of pixels of which represents at least luminance of reflected light from the first imaging target object; a display device; and a processing device. The processing device executes: acquiring the first image from the first imaging device; acquiring the second image from the second imaging device; specifying, based on the first image, a first region occupied by the identification target object in the first image; identifying a type of the identification target object based on an image of a second region corresponding to the first region in the second image; and causing the display device to display, over the identification target object, a fourth image corresponding to the type of the identification target object.

A non-transitory computer-readable storage medium according to an aspect of the present disclosure stores a program, the program causing a computer to execute: acquiring a first image, a pixel value of each of pixels of which represents a distance of a first imaging target object including a background object and an identification target object from a first position; acquiring a second image captured from the first position or a second position different the first position, a pixel value of each of pixels of the second image representing at least luminance of reflected light from the first imaging target object; specifying, based on the first image, a first region occupied by the identification target object in the first image; and identifying a type of the identification target object based on an image of a second region corresponding to the first region in the second image.

A non-transitory computer-readable storage medium according to an aspect of the present disclosure stores a program, the program causing a computer to execute: acquiring a first image, a pixel value of each of pixels of which represents a distance of a first imaging target object including a background object and an identification target object from a first position; acquiring a second image captured from the first position or a second position different the first position, a pixel value of each of pixels of the second image representing at least luminance of reflected light from the first imaging target object; specifying, based on the first image, a first region occupied by the identification target object in the first image; identifying a type of the identification target object based on an image of a second region corresponding to the first region in the second image; and displaying, over the identification target object, a fourth image corresponding to the type of the identification target object.

### BRIEF DESCRIPTION OF THE DRAWINGS

FIG. 1 is a block diagram showing a configuration example of an image display system including a display control device that executes an image display method according to an embodiment of the present disclosure.

FIG. 2 is a diagram showing an example of an imaging target object in the embodiment.

FIG. 3 is a diagram showing an example of a distance image.

FIG. 4 is a diagram showing an example of a luminance image.

FIG. 5 is a diagram showing an example of a reference image.

FIG. 6 is a diagram showing an example of a first region of interest specified based on the reference image and the distance image.

FIG. 7 is a diagram showing an example of a second region of interest in the luminance image.

FIG. 8 is a flowchart showing a flow of an image display method in the embodiment.

### DESCRIPTION OF EXEMPLARY EMBODIMENTS

An embodiment of the present disclosure is explained below with reference to the drawings. Technically preferred various limitations are added to the embodiment explained below. However, embodiments of the present disclosure are not limited to the embodiment explained below.

### 1. Embodiment

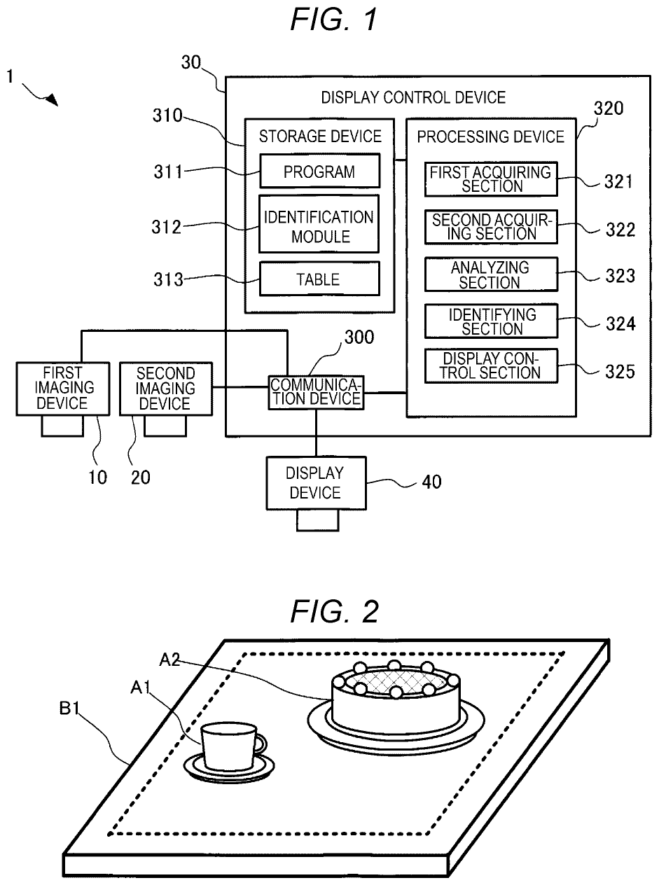

FIG. 1 is a block diagram showing a configuration example of an image display system 1 including a display control device 30 that executes an image display method according to an embodiment of the present disclosure. As shown in FIG. 1, the image display system 1 includes, besides the display control device 30, a first imaging device 10, a second imaging device 20, and a display device 40. As shown in FIG. 1, the first imaging device 10, a second imaging device 20, and the display device 40 are connected to the display control device 30 via a communication line or the like.

The display device 40 displays an image under control by the display control device 30. The display device 40 in this embodiment is a projector. The display control device 30 identifies, based on a captured image of an imaging target object including an object to be a background and an object to be an identification target, a type of the object to be the identification target. In the following explanation, the object to be the background is referred to as background object. The object to be the identification target is referred to as identification target object. The imaging target object including the background object and the identification target object is an example of the first imaging target object in the present disclosure. The display control device 30 controls the display device 40 to display, according to an identification result about the type of the identification target object, over the identification target object, an image for decorating the identification target object.

FIG. 2 is a diagram showing an example of an imaging target object in this embodiment. In this embodiment, a desk B1 is the background object. In this embodiment, a cup A1 disposed on the desk B1 is the identification target object and a cake A2 disposed on the desk B1 is also the identification target object. In this embodiment, all of a top plate of the desk B1, the cup A1, and the cake A2 have tints close to white.

The first imaging device 10 is a distance camera such as a ToF camera, a structured optical camera, or a stereo camera. The distance camera is a camera that captures a distance image. The distance image is an image, a pixel value of each of pixels of which represents the distance from an imaging target object to a setting position of the distance camera. Every time the first imaging device 10 images the imaging target object, the first imaging device 10 outputs image data representing the captured distance image to the display control device 30. In the following explanation, the image data representing the distance image is referred to as distance image data.

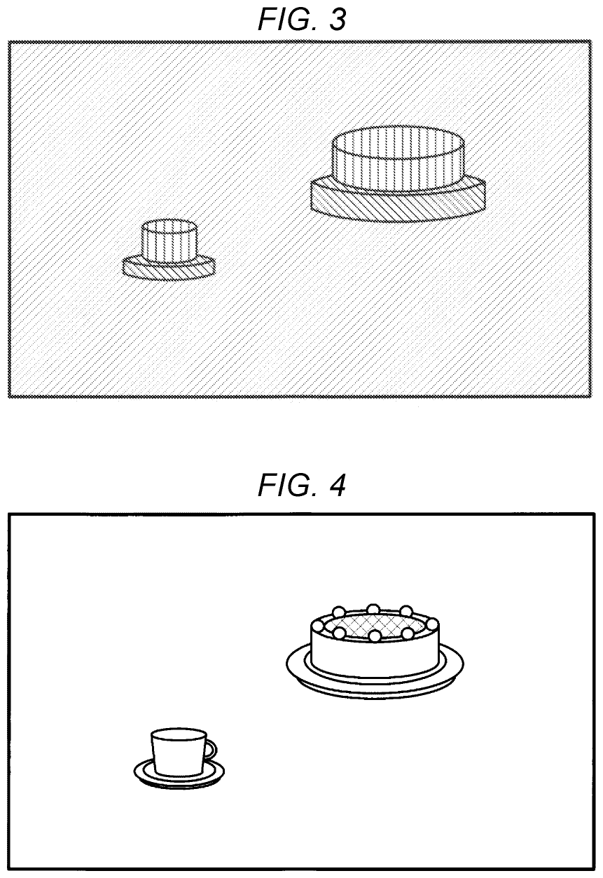

The first imaging device 10 is fixed in an obliquely upward position of the imaging target object shown in FIG. 2. The first imaging device 10 images a range surrounded by a broken line in FIG. 2 in every frame period having a predetermined time length. FIG. 3 is a diagram showing an example of a distance image obtained by imaging the imaging target object shown in FIG. 2 with the first imaging device 10. The distance image in this embodiment is a gray scale image. However, in FIG. 3, the distance from the first imaging device 10 is represented by hatching. In the example shown in FIG. 3, the distance from the first imaging device 10 increases in the order of vertical line hatching, right-downward hatching, and right-upward hatching. A setting position of the first imaging device 10 is an example of the first position in the present disclosure. The distance image obtained by imaging the imaging target object shown in FIG. 2 with the first imaging device 10 is an example of the first image in the present disclosure.

The second imaging device 20 is an RGB camera. A pixel value of each of pixels in an image captured by the second imaging device 20 represents luminance and a color of reflected light from the imaging target object. In the following explanation, the image, the pixel value of each of the pixels of which represents at least the luminance of the reflected light from the imaging target object, is referred to as luminance image. The second imaging device 20 in this embodiment is the RGB camera. However, the second imaging device 20 may be a gray camera or an infrared camera. The second imaging device 20 is fixed to a position different from the setting position of the first imaging device 10. A setting position of the second imaging device 20 is an example of the second position in the present disclosure. The luminance image obtained by imaging the imaging target object shown in FIG. 2 with the second imaging device 20 is an example of the second image in the present disclosure.

Like the first imaging device 10, the second imaging device 20 images, in every frame period, the range surrounded by the broken line in FIG. 2 from obliquely above the imaging target object shown in FIG. 2. In this embodiment, imaging timing by the second imaging device 20 and imaging timing by the first imaging device 10 are the same. The second imaging device 20 outputs, to the display control device 30, image data representing a luminance image captured every time the second imaging device 20 images the imaging target object. In the following explanation, the image data representing the luminance image is referred to as luminance image data.

FIG. 4 is a diagram showing an example of the luminance image obtained by imaging the imaging target object shown in FIG. 2 with the second imaging device 20. In this embodiment, zooming in the second imaging device 20 and zooming in the first imaging device 10 are set to the same value. Accordingly, the distance image captured by the first imaging device 10 and the luminance image captured by the second imaging device 20 are images obtained by imaging the same imaging range from substantially the same position at substantially the same zooming.

The display control device 30 specifies a region occupied by the identification target object based on the distance image captured by the first imaging device 10. The display control device 30 identifies a type of the identification target object based on the luminance image. The display control device 30 controls the display device 40 to display a decorative image corresponding to an identification result based on the luminance image. The display control device 30 markedly indicating characteristics of this embodiment is mainly explained below.

The display control device 30 is, for example, a personal computer. As shown in FIG. 1, the display control device 30 includes a communication device 300, a storage device 310, and a processing device 320. The first imaging device 10, the second imaging device 20, and the display device 40 are connected to the communication device 300. The communication device 300 receives distance image data output from the first imaging device 10. The communication device 300 includes luminance image data output from the second imaging device 20. The communication device 300 outputs image data representing an image projected onto the identification target object to the display device 40.

The storage device 310 is a recording medium readable by the processing device 320. The storage device 310 includes, for example, a nonvolatile memory and a volatile memory. The nonvolatile memory is, for example, a ROM (Read Only Memory), an EPROM (Erasable Programmable Read Only Memory), or an EEPROM (Electrically Erasable Programmable Read Only Memory). The volatile memory is, for example, a RAM (Random Access Memory).

A program 311 to be executed by the processing device 320, an identification module 312, and a table 313 are stored in advance in the nonvolatile memory of the storage device 310. The volatile memory of the storage device 310 is used by the processing device 320 as a work area in executing the program 311. The program 311 can also be called “application program”, “application software”, or “application”. The program 311 is acquired from, for example, a not-shown server via the communication device 300 and, thereafter, stored in the storage device 310.

The identification module 312 is a convolutional neural network generated by machine learning such as deep learning using learning data that associates luminance images of objects and labels indicating types of the objects. The identification module 312 has learned about a cup, a cake, a pot, a fork, a spoon, a knife, and the like. When a luminance image of an object is input to the identification module 312, the identification module 312 outputs a label indicating a type of the object reflected in the input luminance image. The identification module 312 is an example of a discriminator in the present disclosure.

In the table 313, aspect ratio data and decorative image data are stored in association with types of objects.

The aspect ratio data indicates an aspect ratio assumed about a region occupied by an object in a distance image captured by the first imaging device 10. In this embodiment, when a value obtained by dividing resolution in the lateral direction by resolution in the longitudinal direction in the region is set as the aspect ratio, values smaller than 2.0 are assumed as the aspect ratio about a spherical object, a circular object, and a cubic object. For example, aspect ratio data indicating values smaller than 2.0 is stored in advance in the table 313 about a cup, a dish, and a teapot. A value equal to or larger than 2.0 and smaller than 10.0 is assumed about a bar-like object. In this embodiment, aspect ratio data indicating a value equal to or larger than 2.0 and smaller than 10.0 is stored in advance in the table 313 about a fork, a spoon, and a knife.

The decorative image data represents a decorative image suitable for decoration of an object of a type stored in the table 313 in association with the decorative image data. The decorative image is an example of the fourth image in the present disclosure. A decorative image about a cake is preferably an image that causes a user to feel celebration. In this embodiment, decorative image data representing an image of a cracker is stored in the table 313 in association with a label indicating the cake. The decorative image about the cake may not be the cracker image but may be an image of a kusudama (a decorative paper ball). A decorative image about a cup is preferably an image that causes the user to feel warmness. In this embodiment, decorative image data representing an image of steam is stored in the table 313 in association with a label indicating the cup. The decorative image about the cup may not be the image of steam but may be an image of a stove. A decorative image about a glass is preferably an image that causes the user to fell coolness. In this embodiment, decorative image data representing an image representing a stream of water such as a water surface of a river, an image that causes the user to feel a flow of wind such as a wind-bell swinging in the air, or the like is stored in the table 313 in association with a label indicating the glass. A decorative image about a pot is preferably an image that causes the user to feel tenderness or peace of mind. In this embodiment, decorative image data representing an image representing light of soft sunshine filtering through trees is stored in the table 313 in association with a label indicating the pot.

The processing device 320 includes a processor such as a CPU (Central Processing Unit), that is, a computer. The processing device 320 may be configured by a single computer or may be configured by a plurality of computers. According to operation for instructing an execution start of the program 311 performed on a not-shown input device, the processing device 320 reads out the program 311 from the nonvolatile memory to the volatile memory and starts execution of the program 311. The processing device 320 operating according to the program 311 functions as a first acquiring section 321, a second acquiring section 322, an analyzing section 323, an identifying section 324, and a display control section 325 shown in FIG. 1. The first acquiring section 321, the second acquiring section 322, the analyzing section 323, the identifying section 324, and the display control section 325 shown in FIG. 1 are software modules realized by causing the processing device 320 to operate according to the program 311.

The first acquiring section 321 acquires distance image data received by the communication device 300. The second acquiring section 322 acquires luminance image data received by the communication device 300.

The analyzing section 323 specifies, based on a distance image indicated by the distance image data acquired by the first acquiring section 321, a first region of interest occupied by an identification target object in the distance image. More specifically, the analyzing section 323 has a reference image generating function for generating a reference image from the distance image data acquired by the first acquiring section 321 and a specifying function for detecting the identification target object based on the distance image represented by the distance image data acquired by the first acquiring section 321 and the reference image and specifying the first region of interest occupied by the identification target object in the distance image. The first region of interest is an example of the first region in the present disclosure.

The reference image is an image serving as a reference in detecting an identification target object from a distance image of an imaging target object including a background object and the identification target object. The reference image in this embodiment is generated based on a plurality of distance images obtained by sequentially imaging a reference imaging target object explained below with the first imaging device 10. For example, the reference object imaged when a disposition position of the background object in the imaging target object including the background object and the identification target object is set as the third position and a disposition position of the identification target object is set as the fourth position is as explained below. The reference object in this case means an imaging target object including the background object and not including the identification target object in a state in which the background object is disposed in the third position and the identification target object is not disposed in the fourth position. The reference object is an example of the second imaging target object in the present disclosure. The analyzing section 323 calculates an average of pixels values of pixels corresponding to the same position in a plurality of distance images and sets an image, a pixel value of a pixel of which corresponding to the position is the average, as the reference image. The background object in this embodiment is the desk B1. The top plate of the desk B1 is planar. Distances from the first imaging device 10 to parts on the top plate of the desk B1 are substantially uniform. Therefore, in this embodiment, as shown in FIG. 5, the reference image indicating that the distances from the first imaging device 10 are substantially uniform is generated. The reference image is an example of the third image in the present disclosure. The reference image only has to be generated in advance prior to execution of an identification method of the present disclosure. In this embodiment, the reference image is generated based on the plurality of distance images obtained by sequentially imaging the reference object with the first imaging device 10. However, any one of these plurality of distance images may be set as the reference image.

By comparing the distance image obtained by the first imaging device 10 and the reference image, the analyzing section 323 detects that an object is placed on the background object, sets the object as the identification target object, and specifies the first region of interest. More specifically, the analyzing unit 323 detects, as a candidate region of the object, a smallest circumscribed quadrangle surrounding a region formed by a pixel, a difference of a pixel value of which from a pixel value in the reference image is equal to or larger than a predetermined value. A plurality of candidate regions may be detected from one distance image. Subsequently, the analyzing section 323 determines, for each of the candidate regions, whether a predetermined reference is satisfied. When the detected candidate region satisfies the predetermined reference, the analyzing section 323 determines that an object is placed on the background object, sets the object as the identification target object, and specifies the candidate region as the first region of interest.

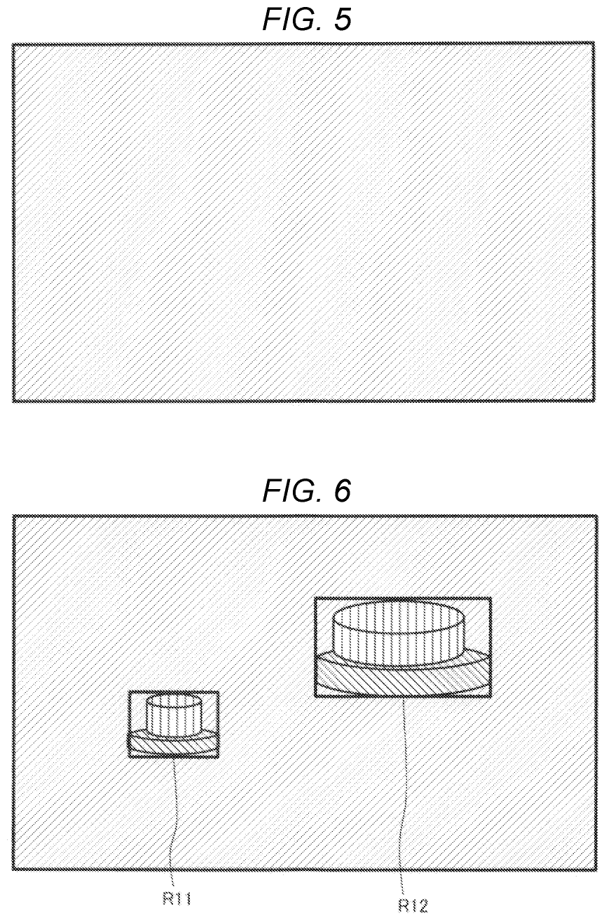

In this embodiment, detection of an object is performed based on an aspect ratio of the candidate region. Specifically, when the aspect ratio of the candidate region coincides with any one of aspect ratios indicated by a plurality of aspect ratio data stored in the table 313 in association with labels of respective objects, the analyzing section 323 specifies the candidate region as the first region of interest. In this embodiment, by comparing the reference image shown in FIG. 5 and the distance image shown in FIG. 3, the analyzing section 323 specifies a first region of interest R11 and a first region of interest R12 as shown in FIG. 6. In this embodiment, the object is detected based on the aspect ratio of the candidate region. However, the object may be detected based on an area of the region formed by the pixel, the difference of the pixel value of which from the pixel value in the reference image is equal to or larger than the predetermined value, or an area of the candidate region.

The identifying section 324 specifies a second region of interest corresponding to the first region of interest in a luminance image represented by luminance image data acquired by the second acquiring section 322. The second region of interest is an example of the second region in the present disclosure. In this embodiment, the identifying section 324 specifies, based on the position and the size of the first region of interest in the distance image, as the second region of interest, a rectangular region occupying the same position and the same size as the first region of interest in the luminance image. Subsequently, the identifying section 324 specifies a type of an identification target object imaged in the second region of interest using an image of the second region of interest and the identification module 312. More specifically, the identifying section 324 inputs image data representing the image of the second region of interest to the identification module 312 and acquires a label output from the identification module 312 to specify the type of the identification target object imaged in the second region of interest. When a plurality of first regions of interest are specified by the analyzing section 323, the identifying section 324 specifies second regions of interest for each of the first regions of interest and specifies the type of the identification target object for each of the second regions of interest.

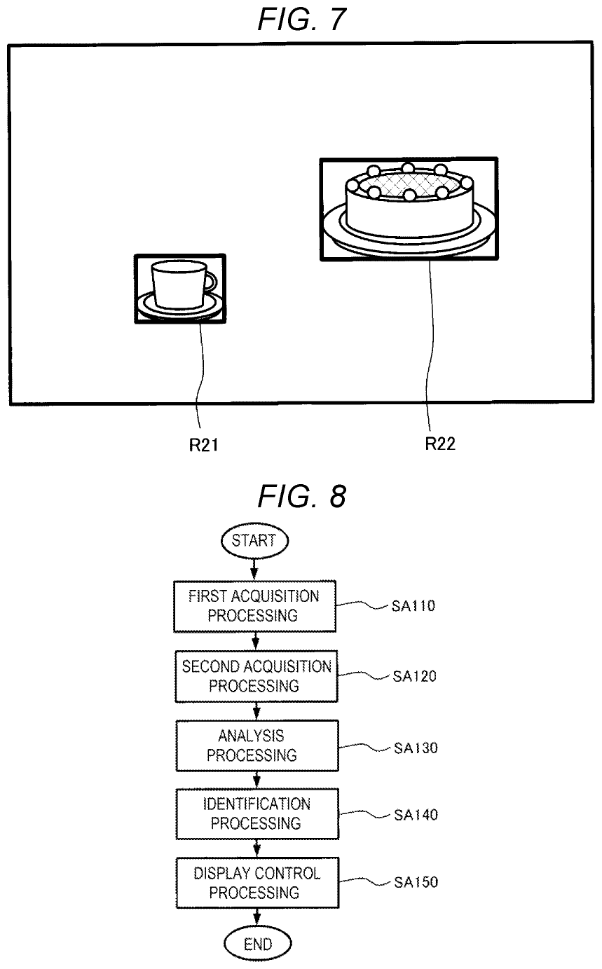

In this embodiment, a second region of interest R21 shown in FIG. 7 is specified by the identifying section 324 with respect to the first region of interest R11 shown in FIG. 6. As shown in FIG. 7, an image of the cup A1, which is the identification target object, occupies most of the second region of interest R21 in the luminance image. Since the identification module 312 has learned a cup, when an image of the second region of interest R21 is input to the identification module 312, the identification module 312 outputs a label indicating the cup. In this embodiment, a second region of interest R22 shown in FIG. 7 is specified by the identifying section 324 with respect to the first region of interest R12 shown in FIG. 6. As shown in FIG. 7, an image of the cake A2, which is the identification target object, occupies most of the second region of interest R22 in the luminance image. Since the identification module 312 has learned about a cake, when the image of the second region of interest R22 is input to the identification module 312, the identification module 312 outputs a label indicating the cake.

The display control section 325 controls the display device 40 to project, over the identification target object, a decorative image corresponding to the type of the identification target object specified by the identifying section 324. More specifically, the display control section 325 reads out, from the table 313, decorative image data corresponding to the label acquired by the identifying section 324. The display control section 325 generates image data of a projection image in which a decorative image represented by the decorative image data read out from the table 313 is arranged such that a center position of the decorative image is a center position of the second region of interest corresponding to the label. The display control section 325 gives the generated image data to the display device 40 to cause the display device 40 to display the decorative image over the identification target object.

As explained above, in this embodiment, a type of an object identified based on the image of the second region of interest R21 is a cup. An image of steam is stored in the table 313 in association with the cup. Accordingly, in this embodiment, the image of steam is projected over the cup A1 from the display device 40. A type of an object identified based on the image of the second region of interest R22 is a cake. A cracker image is stored in the table 313 in association with the cake. Accordingly, in this embodiment, the cracker image is projected over the cake A2 from the display device 40.

The processing device 320 operating according to the program 311 executes an image display method in the embodiment of the present disclosure. FIG. 8 is a flowchart showing a flow of the image display method. As shown in FIG. 8, the image display method includes first acquisition processing SA110, second acquisition processing SA120, analysis processing SA130, identification processing SA140, and display control processing SA150.

In the first acquisition processing SA110, the processing device 320 functions as the first acquiring section 321. In the first acquisition processing SA110, the processing device 320 acquires distance image data received by the communication device 300. In the second acquisition processing SA120 following the first acquisition processing SA110, the processing device 320 functions as the second acquiring section 322. In the second acquisition processing SA120, the processing device 320 acquires luminance image data received by the communication device 300. In this embodiment, the second acquisition processing SA120 is executed following the first acquisition processing SA110. However, execution order of the first acquisition processing SA110 and the second acquisition processing SA120 may be changed.

In the analysis processing SA130 following the second acquisition processing SA120, the processing device 320 functions as the analyzing section 323. In the analysis processing SA130, the processing device 320 specifies a first region of interest based on the distance image data received by the communication device 300.

In the identification processing SA140 following the analysis processing SA130, the processing device 320 functions as the identifying section 324. In the identification processing SA140, the processing device 320 inputs an image of a second region of interest corresponding to the first region of interest specified by the analysis processing SA130 to the identification module 312 as an identification target image and acquires a label of a type of an object imaged in the identification target image.

In the display control processing SA150 following the identification processing SA140, the processing device 320 functions as the display control section 325. In the display control processing SA150, the processing device 320 controls the display device 40 to project, over the identification target object, a decorative image corresponding to the label acquired in the identification processing SA140.

According to this embodiment, a region where an identification target object is present is specified based on a distance image. Accordingly, even if a color of a background object and a color of the identification target object are similar tints, it is possible to accurately specify the region where the identification target object is present. It is possible to improve identification accuracy for a type of the identification target object based on a luminance image. Since the identification accuracy for the type of the identification target object based on the luminance image is improved, according to this embodiment, it is possible to avoid a decorative image not suitable for the identification target object being displayed over the identification target object because of an identification error of the type of the identification target object.

### 2. Modifications

The embodiment may be changed as explained below.

(1) The display control device 30 in the embodiment is the personal computer but may be a smartphone or a tablet terminal. The identification module 312 is not limited to the convolutional neural network and only has to be a discriminator configured by a non-rule-based method for forming identification parameters from a large amount of data such as machine learning performed using image feature values. The display device 40 in the embodiment is the projector but may be a liquid crystal display. When the display device 40 is the liquid crystal display, the display device 40 can be used like AR for superimposing, on a luminance image of the imaging target object, contents corresponding to a position and a type of the identification target object imaged in the luminance image.

(2) In the embodiment, the distance image and the reference image are compared to specify the first region of interest. However, edge detection may be applied to the distance image to set a detected edge as a contour line of the first region of interest. The edge means a pixel, a pixel value of which suddenly changes when pixel values are sampled in a horizontal scanning direction or a vertical scanning direction of an image. Usually, pixel values are different in a pixel corresponding to an identification target object and a pixel corresponding to a background object in a distance image of an imaging target object. That is, usually, a contour line of the identification target object is the edge in the distance image of the imaging target object. Accordingly, by detecting the edge from the distance image of the imaging target object, the contour line of the identification target object imaged in the distance image can be detected. A region surrounded by the contour line may be set as the first region of interest.

(3) In the embodiment, the distance image and the luminance image are respectively captured by the different cameras. However, instead of the first imaging device 10 and the second imaging device 20, one camera including both of an imaging function for the distance image and an imaging function for the luminance image may be used. When the one camera including both of the imaging function for the distance image and the imaging function for the luminance image is used, the distance image and the luminance image are captured from the same position. A setting position of the camera including both of the imaging function for the distance image and the imaging function for the luminance image is an example of the first position in the present disclosure.

(4) The first acquiring section 321, the second acquiring section 322, the analyzing section 323, the identifying section 324, and the display control section 325 in the embodiment are the software modules. However, a part or all of the first acquiring section 321, the second acquiring section 322, the analyzing section 323, the identifying section 324, and the display control section 325 may be hardware. Examples of the hardware include a DSP (Digital Signal Processor), an ASIC (Application Specific Integrated Circuit), a PLD (Programmable Logic Device), and an FPGA (Field Programmable Gate Array). Even if a part or all of the first acquiring section 321, the second acquiring section 322, the analyzing section 323, the identifying section 324, and the display control section 325 are hardware, the same effects as the effects in the embodiment are achieved.

(5) In the embodiment, the program 311 has been stored in the storage device 310. However, the program 311 may be manufactured or distributed alone. As a specific distribution method for the program 311, an aspect of writing the program 311 in a computer-readable recording medium such as a flash ROM (Read Only Memory) and distributing the program 311 or an aspect of distributing the program 311 by downloading the program 311 through an electric communication line such as the Internet is conceivable.

(6) In the embodiment, the display control device 30 including the first acquiring section 321, the second acquiring section 322, the analyzing section 323, the identifying section 324, and the display control section 325 is explained. However, the display control section 325 may be omitted from the display control device 30 to configure an identification device that specifies, based on a distance image, a first region where an identification target object is present and identifies a type of the identification target object based on an image of a second region corresponding to the first region in a luminance image. The identification device, the first imaging device 10, and the second imaging device 20 may be combined to configure an identification system. With the identification device including the first acquiring section 321, the second acquiring section 322, the analyzing section 323, and the identifying section 324, even if a color of a background object and a color of the identification target object are similar tints, it is possible to accurately specify a region where the identification target object is present. It is possible to improve identification accuracy for a type of the identification target object based on the luminance image.

Similarly, the display control processing SA150 may be omitted from the image display method in the embodiment to configure an identification method for specifying, based on a distance image, a first region where an identification target object is present and identifying a type of the identification target object based on an image of a second region corresponding to the first region in a luminance image. With the identification method including the first acquisition processing SA110, the second acquisition processing SA120, the analysis processing SA130, and the identification processing SA140, even if a color of a background object and a color of the identification target object are similar tints, it is possible to accurately specify a region where the identification target object is present. It is possible to improve identification accuracy for a type of the identification target object based on the luminance image. A program for causing a computer to execute the identification method may be provided.

### 3. Aspects Grasped from at Least One of the Embodiment and the Modifications

The present disclosure is not limited to the embodiment and the modifications explained above and can be realized in various aspects without departing from the gist of the present disclosure. For example, the present disclosure can also be realized by aspects described below. Technical features in the embodiment corresponding to technical features in the aspects described below can be substituted or combined as appropriate in order to solve apart or all of the problems of the present disclosure or attain a part or all of the effects of the present disclosure. Unless the technical features are explained in this specification as essential technical features, the technical features can be deleted as appropriate.

In order to solve the problems described above, an aspect of the identification method according to the present disclosure includes the first acquisition processing SA110, the second acquisition processing SA120, the analysis processing SA130, and the identification processing SA140. In the first acquisition processing SA110, a first image obtained by imaging, with the first imaging device 10 set in a first position, a first imaging target object including a background object such as a desk and an identification target object is acquired. The first imaging device 10 is a distance camera. The first image is a distance image. A pixel value of each of pixels in the first image represents the distance from the first position to the first imaging target object. In the second acquisition processing SA120, a second image obtained by imaging the first imaging target object with the second imaging device 20 set in the first position or a second position different from the first position is acquired. The second image is a luminance image. A pixel value of each of pixels in the second image represents at least luminance of reflected light from the first imaging target object. In the analysis processing SA130, a first region occupied by the identification target object in the first image is specified based on the first image. In the identification processing SA140, a type of the identification target object is identified based on an image of a second region in the second image, the second region corresponding to the first region specified by the analysis processing SA130.

According to this aspect, a region where the identification target object is present is specified based on the first image, which is the distance image, prior to the identification of the type of the identification target object based on the second image, which is the luminance image. Accordingly, according to this aspect, even if a color of the background object and a color of the identification target object are similar tints, it is possible to accurately specify the region where the identification target object is present. It is possible to improve identification accuracy for the type of the identification target object based on the luminance image. According to this aspect, since the region where the identification target object is present is specified based on the distance image, it is also possible to distinguish the identification target object and an image of the identification target object.

In the identification processing SA140, a type of an identification target object may be identified using the identification module 312, which is an example of a discriminator that has learned, in advance, learning data associating images of objects and labels indicating types of the objects and outputs a label indicating a type of an object imaged in an input image. According to this aspect, it is possible to identify the type of the identification target object using the discriminator.

In the analysis processing SA130, a reference image obtained by imaging a second imaging target object with a first imaging device from a first position may be acquired. A first region may be specified by comparing a distance image obtained by imaging a first imaging target object with the first imaging device from the first position and the reference image. The second imaging target object imaged when a background object is disposed in a third position and an identification target object is disposed in a fourth position in the first imaging target object means an imaging target object including the background object and not including the identification target object in a state in which the background object is disposed in the third position and the identification target object is not disposed in the fourth position. According to this aspect, it is possible to specify the first region by comparing the reference image and a first image.

In order to solve the problems described above, an aspect of the image display method according to the present disclosure includes the display control processing SA150 besides the first acquisition processing SA110, the second acquisition processing SA120, the analysis processing SA130, and the identification processing SA140. In the display control processing SA150, a fourth image corresponding to a type of an identification target object, the fourth image being an image for decorating the identification target object, is displayed over the identification target object. According to this aspect, even if a color of a background object and a color of the identification target object are similar tints, it is possible to accurately specify a region where the identification target object is present. It is possible to improve identification accuracy for a type of the identification target object based on a luminance image. Since the identification accuracy for the type of the identification target object based on the luminance image is improved, according to this aspect, it is possible to avoid the fourth image not suitable for the type of the identification target object being displayed over the identification target object.

In order to solve the problems described above, an aspect of the identification system according to the present disclosure includes the first imaging device 10 set in a first position, the second imaging device 20 set in the first position or a second position different from the first position, and the processing device 320. The processing device 320 executes the first acquisition processing SA110, the second acquisition processing SA120, the analysis processing SA130, and the identification processing SA140. According to this aspect as well, when a color of a background object and a color of an identification target object are similar tints, it is possible to accurately specify a region where the identification target object is present. It is possible to improve identification accuracy for a type of the identification target object based on a luminance image.

In order to solve the problems described above, an aspect of the image display system according to the present disclosure includes the first imaging device 10 set in a first position, the second imaging device 20 set in the first position or a second position different from the first position, the display device 40, which is an example of a display device, and the processing device 320. The processing device 320 executes the first acquisition processing SA110, the second acquisition processing SA120, the analysis processing SA130, the identification processing SA140, and the display control processing SA150 explained above. According to this aspect, even if a color of a background object and a color of an identification target object are similar tints, it is possible to accurately specify a region where the identification target object is present. It is possible to improve identification accuracy for a type of the identification target object based on a luminance image. Since the identification accuracy for the type of the identification target object based on the luminance image is improved, according to this aspect, it is possible to avoid a fourth image not suitable for the type of the identification target object being displayed.

In order to solve the problems described above, an aspect of the program according to the present disclosure causes the processing device 320, which is an example of a computer, to execute the first acquisition processing SA110, the second acquisition processing SA120, the analysis processing SA130, and the identification processing SA140. According to this aspect, even if a color of a background object and a color of an identification target object are similar tints, it is possible to accurately specify a region where the identification target object is present. It is possible to improve accuracy of an identification result of the identification target object based on a luminance image.

Another aspect of the program according to the present disclosure causes the processing device 320, which is an example of a computer, to execute the first acquisition processing SA110, the second acquisition processing SA120, the analysis processing SA130, the identification processing SA140, and the display control processing SA150. According to this aspect, even if a color of a background object and a color of an identification target object are similar tints, it is possible to accurately specify a region where the identification target object is present. It is possible to improve identification accuracy for a type of the identification target object based on a luminance image. Since the identification accuracy for the type of the identification target object based on the luminance image is improved, according to this aspect, it is possible to avoid a fourth image not suitable for the type of the identification target object being displayed.

What is claimed is:

1. An identification method comprising:
acquiring a first image, a pixel value of each of pixels of which represents a distance from a first position to a first imaging target object including a background object and an identification target object;
acquiring a second image captured from the first position or a second position different the first position, a pixel value of each of pixels of the second image representing at least luminance of reflected light from the first imaging target object;
specifying, based on the first image, a first region occupied by the identification target object in the first image; and
identifying a type of the identification target object based on an image of a second region corresponding to the first region in the second image.

2. The identification method according to claim 1, wherein the type of the identification target object identified by inputting an image of the second region to a discriminator that learned learning data associating images of objects and labels indicating types of the objects and outputs a label indicating a type of an object imaged in an input image.

3. The identification method according to claim 1, wherein the background object is disposed in a third position and the identification target object is disposed in a fourth position in the first imaging target object,
the identification method further comprises, acquiring a third image, a pixel value of each of pixels of which represents a distance from the first position to a second imaging target object including the background object and not including the identification target object, in a state in which the background object is disposed in the third position and the identification target object is not disposed in the fourth position, and wherein
the first region specified by comparing the third image and the first image.

4. An identification system comprising:
a first imaging device set in a first position and configured to capture a first image, a pixel value of each of pixels of which represents a distance from the first position to a first imaging target object including a background object and an identification target object;
a second imaging device set in the first position or a second position different from the first position and configured to capture a second image, a pixel value of each of pixels of which represents at least luminance of reflected light from the first imaging target object; and
at least one processor executes:
acquiring the first image from the first imaging device;
acquiring the second image from the second imaging device;
specifying, based on the first image, a first region occupied by the identification target object in the first image; and
identifying a type of the identification target object based on an image of a second region corresponding to the first region in the second image.

5. A non-transitory computer-readable storage medium storing a program, the program causing a computer to execute:
acquiring a first image, a pixel value of each of pixels of which represents a distance from a first position to a first imaging target object including a background object and an identification target object;
acquiring a second image captured from the first position or a second position different the first position, a pixel value of each of pixels of the second image representing at least luminance of reflected light from the first imaging target object;
specifying, based on the first image, a first region occupied by the identification target object in the first image; and
identifying a type of the identification target object based on an image of a second region corresponding to the first region in the second image.
